(19) United States
(12) Patent Application Publication
(10) Pub. No.: US 2006/0020701 A1
(43) Pub. Date: Jan. 26, 2006

(54) Thread transfer between processors

(76) Inventors: Harshadrai G. Parekh, San Jose, CA (US); Swapneel A. Kekre, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/074,973

(22) Filed: Mar. 7, 2005

Related U.S. Application Data
(60) Provisional application No. 60/589,723, filed on Jul. 21, 2004.

(51) Int. Cl. G06F 15/173

(52) U.S. Cl. 709/226

(57) ABSTRACT

Apparatus and methods are provided for transferring threads. One embodiment of a computing device includes a number of processors including a first processor, a memory in communication with the at least one of the number of processors, and computer executable instructions stored in memory and executable on at least one of the number of processors. The computer executable instructions include instructions to select a second processor, wherein the selection is based upon proximity of the second processor to the first processor. Computer executable instructions also include instructions to select a thread for transfer from the second processor and transfer the selected thread from the second processor to the first processor.

### CROSS-REFERENCE TO RELATED APPLICATIONS

This application claims the benefit of U.S. Provisional Application No. 60/589,723, filed Jul. 21, 2004, the entire content of which is incorporated herein by reference.

### INTRODUCTION

Multiprocessor devices and systems include a number of processors that are used in combination to execute processes (i.e. computer executable instructions), such as in operating systems, program applications, and the like. Computer executable instructions can be provided in the form of a number of threads. In multiprocessor devices and systems, threads can be directed to a processor for execution in various manners. For example, threads of a particular type can be assigned to a particular processor. Additionally, a number of threads from a program application or that provide a particular function can be assigned to the same processor for execution. The threads can also be assigned to one of a number of processors.

A process is a container for a set of instructions that carry out the overall task of a program application. Processes include running program applications, managed by operating system programs such as a scheduler and a memory management program.

A process usually includes text (the code that a process runs), data (used by the code), and stack (memory used when a process is running). These and other elements are known as the process context.

Many devices use thread based processing in which each process is made up of one or more threads. A process can be viewed as a container for groups of threads. In some devices and systems, a process can hold the address space and shared resources for all the threads in a program in one place. When threads are used, threads are the execution entities and processes are containers having a number of threads therein.

The most common thread types are user threads and kernel threads. User threads are those which a program application creates. Kernel threads are those which the kernel can “see” and schedule.

A user program application can implement a multithreaded application without kernel threads by implementing a user-space scheduler to switch between the various threads for the process. These threads are referred to as unbound, since they do not correspond to a thread the kernel can see and schedule. If each of these threads is bound to a kernel thread, then the kernel scheduler is used, since the user threads are tied to a kernel thread. These threads are referred to as bound.

Two stacks are associated with a thread; the kernel stack and user stack. The thread uses the user stack when in user space and the kernel stack when in kernel space. Although threads appear to the user to run simultaneously, a processor executes one thread at any given instant.

A process is a representation of an entire running program. By comparison, a kernel thread is a fraction of that program. Like a process, a thread is a sequence of instructions being executed in a program. Kernel threads exist within the context of a process and provide the operating system the means to address and execute smaller segments of the process. It also enables programs to take advantage of capabilities provided by the hardware for concurrent and parallel processing.

The concept of threads can be interpreted numerous ways, but generally, threads allow applications to be broken up into logically distinct tasks that, when supported by hardware, can be run in parallel. Each thread can be scheduled, synchronized, and prioritized. Threads can share many of the resources, used during the execution of a process, which can eliminate much of the overhead involved during creation, termination, and synchronization.

In a multiprocessor environment, each processor may have a separate run queue. In many devices and systems, once a thread is put on a run queue for a particular processor, it remains there until it is executed. When a thread is ready to be executed, it is directed to the designated processor.

To keep the relative load balanced among processors, many devices and systems use a load balancer to take threads waiting in a queue of one processor and move them to a shorter queue on another processor. In such implementations, the load balancer usually is configured to search the processors by the order they have been connected to the system or device. However, the distance between the short queue processor and the queue of the processor with the thread to be moved can be greater between some processors and others.

For example, this is the case in Non-Uniform Memory Access (NUMA) systems and devices. NUMA systems and devices are arranged such that some resources (e.g., memory) take longer to access than others. Architectures such as NUMA introduce the concepts of distance and local and remote memory.

The distance of a particular resource can, for example, be described as the latency of the access of the resource as compared to the resource(s) with the shortest latency. Resources having the shortest latency times can be referred to as local resources and are typically physically located nearest to the processor executing a particular process. Additionally, resources having the same latency are often referred to as being within the same locality or node. Remote resources are resources that have latency time longer than the one or more local resources, such as those within a locality. These distances may affect the performance of the device or system.

### BRIEF DESCRIPTION OF THE DRAWINGS

FIG. 1 illustrates an example of a multiprocessor computing device.

FIG. 2 illustrates an exemplary multiprocessor system.

FIG. 3 illustrates an exemplary multiprocessor system including a number of localities.

FIG. 4 illustrates an example of the distances between a number of localities.

FIG. 5 illustrates a method embodiment for selecting a thread for transfer.

FIG. 6 illustrates another method embodiment for selecting a thread for transfer.

### DETAILED DESCRIPTION

Computing device and system designs have evolved to include operating systems that distribute execution of computer executable instructions among several processors. Such devices and systems are generally called “multi-processor systems”. In some multi-processor systems, the processors share memory and a clock.

In various multi-processor systems, communication between processors can take place through shared memory. In other multi-processor systems, each processor has its own memory and clock and the processors communicate with each other through communication channels such as high-speed buses or telephone lines, among others.

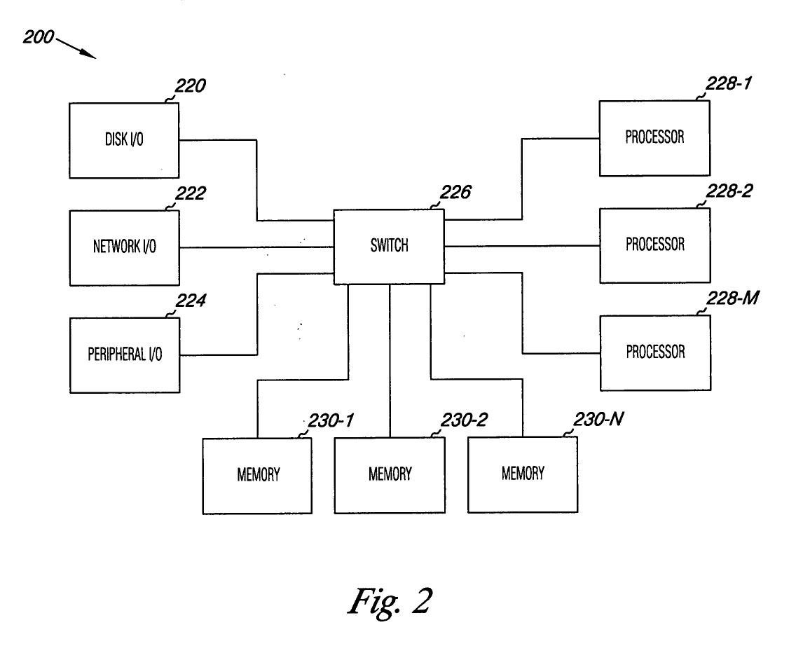

An illustration of a multi-processor system is shown in FIG. 2 and will be described in more detail below. In such configurations, the execution of computer executable instructions can be assigned to particular processors. This assignment, of what computer executable instructions are processed by what processor, is usually accomplished by software or firmware within the device or system.

However, situations can arise where one processor is idle and can be used to execute a thread that may be waiting in the queue of another processor. Idle processors can be defined in various ways, such as those not executing any threads, those not executing kernel threads, those not executing any threads of a process, and other such definitions. Those of ordinary skill in the art will understand from reading the present disclosure that embodiments of the present invention can be used with respect to these and other various definitions of an idle processor.

In searching for a thread to be transferred for execution on the idle processor, efficiencies can be achieved by searching those processors that have the lowest amount of latency first. As discussed above, this notion of latency is often discussed in the context of distance, wherein the latency of a resource is referred to as a distance. If lowest latency resources are searched first, some delays can be accounted for and can be reduced.

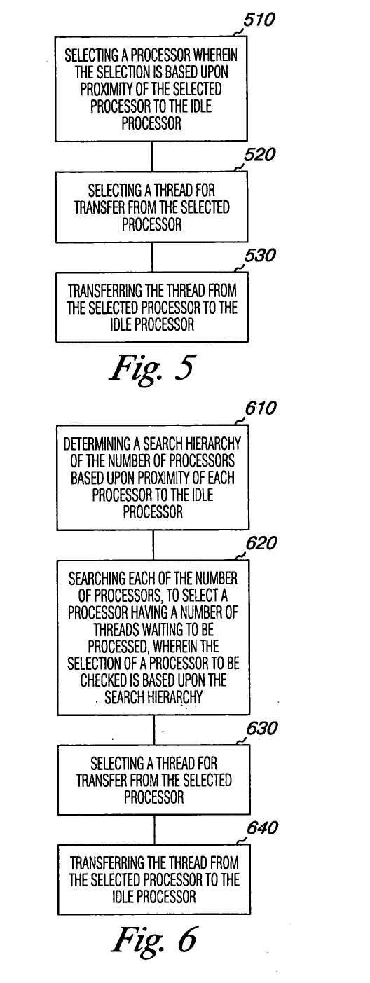

Embodiments of the present invention allow threads that are queued for execution by a first processor to be migrated for execution by one or more other processors if the first processor is busy processing other threads. In this way, threads can be processed more quickly. This function can be accomplished in a number of manners, as will be described below with respect to FIGS. 5 and 6.

Embodiments of the present invention include computer executable instructions which can execute to manage threads on a system or device having multiple processors, such as a network server or other suitable device. In this way, queued threads may not have to wait for a particular processor to become available.

Rather, threads can be shifted from a busy processor to a processor that is available or may be available in a shorter timeframe than the processor for which the threads have been waiting. Embodiments can, therefore, increase the speed and efficiency of a multiprocessor system or device by utilizing resources that are available to process threads instead of having them wait until the processor for which they are waiting becomes available.

In various embodiments, systems and devices can search a number of processors to determine whether a thread can be transferred from the waiting queue of one processor to an idle processor. For example, the processors can be assigned weights or organized in a hierarchy in order to determine the order in which the processors are to be searched. In various embodiments, the processors can be searched from closest, or most proximate, to furthest, or least proximate, from an idle processor.

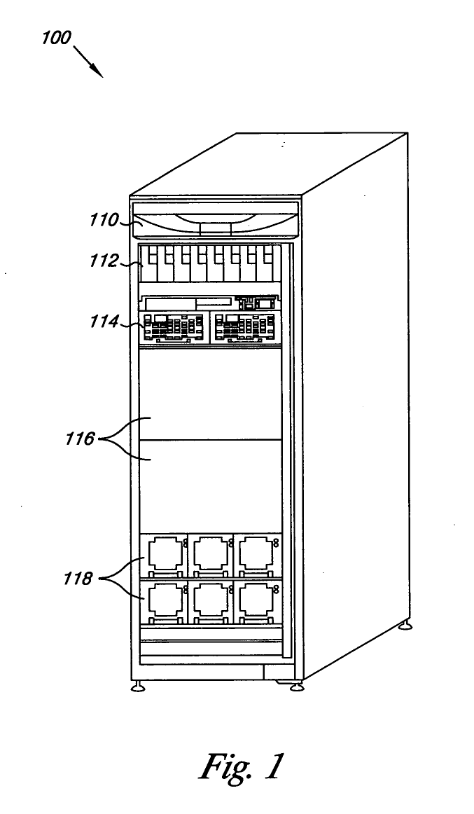

FIG. 1 illustrates an example of a multiprocessor computing device for handling threads. The computing device 100 includes a user control panel 110, memory 112, a number of Input/Output (I/O) components 114, a number of processors 116, and a number of power supplies 118.

Computing device 100 can be any device that can execute computer executable instructions. For example, computing devices can include desktop personal computers (PCs), workstations, and/or laptops, among others.

A computing device 100 can be generally divided into three classes of components: hardware, operating system, and program applications. The hardware, such as a processor (e.g., one of a number of processors), memory, and I/O components, each provide basic computing resources.

Embodiments of the invention can also reside on various forms of computer readable mediums. Those of ordinary skill in the art will appreciate from reading this disclosure that a computer readable medium can be any medium that contains information that is readable by a computer. For example, the computing device 100 can include memory 112 which is a computer readable medium. The memory included in the computing device 100 can be of various types, such as ROM, RAM, flash memory, and/or some other types of volatile and/or nonvolatile memory.

The various types of memory can also include fixed or portable memory components, or combinations thereof. For example, memory mediums can include storage mediums such as, but not limited to, hard drives, floppy discs, memory cards, memory keys, optically readable memory, and the like.

Operating systems and/or program applications can be stored in memory. An operating system controls and coordinates the use of the hardware among a number of various program applications executing on the computing device or system. Operating systems are a number of computer executable instructions that are organized in program applications to control the general operation of the computing device. Operating systems include Windows, Unix, and/or Linux, among others, as those of ordinary skill in the art will appreciate.

Program applications, such as database management programs, software programs, business programs, and the like, define the ways in which the resources of the computing device are employed. Program applications are a number of computer executable instructions that process data for a user. For example, program applications can process data for such computing functions as managing inventory, calculating payroll, assembly and management of spreadsheets, word processing, managing network and/or device functions, and other such functions as those of ordinary skill in the art will appreciate from reading this disclosure.

As shown in FIG. 1, embodiments of the present invention can include a number of Input/Output (I/O) components 114. Computing devices can have various numbers of I/O components and each of the I/O components can be of various different types. These I/O components can be integrated into a computing device 100 and/or can be removably attached, such as to an I/O port. For example, I/O components can be connected via serial, parallel, Ethernet, and Universal Serial Bus (USB) ports, among others.

Some types of I/O components can also be referred to as peripheral components or devices. These I/O components are typically removable components or devices that can be added to a computing device to add functionality to the device and/or a computing system. However, I/O components include any component or device that provides added functionality to a computing device or system. Examples of I/O components can be printing devices, scanning devices, faxing devices, memory storage devices, network devices (e.g., routers, switches, buses, and the like), and other such components.

I/O components can also include user interface components such as display devices, including touch screen displays, keyboards and/or keypads, and pointing devices such as a mouse and/or stylus. In various embodiments, these types of I/O components can be used in compliment with the user control panel 110 or instead of the user control panel 110.

In FIG. 1, the computing device 100 also includes a number of processors 116. Processors are used to execute computer executable instructions that make up operating systems and program applications. Processors are used to process threads and can include executable instructions including hierarchies for processing threads.

According to various embodiments of the invention, a processor can also execute instructions regarding transferring a thread from one processor to another, as described herein, and criteria for selecting when to transfer a thread. These computer executable instructions can be stored in memory, such as memory 112, for example.

In various embodiments of multiprocessor systems and devices, the structure of the computing environment of the device or system can be divided into a number of localities as will be described in more detail below. In various embodiments, the illustrated multiprocessor structure shown in FIG. 2 can be used to represent a locality.

FIG. 2 illustrates an exemplary multiprocessor system. The system 200 of FIG. 2 includes a number of I/O components 220, 222, and 224, a switch 226, a number of processors 228-1 to 228-M, and a number of memory components 230-1 to 230-N.

The designators “N” and “M” are used to indicate that a number of processors and/or memory components can be attached to the system 200. The number that N represents can be the same or different from the number represented by M.

The system 200 of FIG. 2 includes a disk I/O component 220, a network I/O component 222, and a peripheral I/O component 224. The disk I/O component 220 can be used to connect a hard disk to a computing device. The connection between the disk I/O component 220 and processors 228-1 to 228-M allows information to be passed between the disk I/O component and one or more of the processors 228-1 to 228-M.

The embodiment illustrated in FIG. 2 also includes a network I/O component 222. Network I/O components can be used to connect a number of computing and/or peripheral devices within a networked system or to connect one networked system to another networked system. The network I/O component 222 also can be used to connect the networked system 200 to the Internet.

System 200 of FIG. 2 also includes a peripheral I/O component 224. The peripheral I/O component 224 can be used to connect one or more peripheral components to the processors 228-1 to 228-M. For example, a computing system can have fixed or portable external memory devices, printers, keyboards, displays, and other such peripherals connected thereto.

The embodiment of FIG. 2 also includes a switch 226, a number of processors 228-1 to 228-M, and a number of memory components 230-1 to 230-N. The switch 226 can be used to direct information between the I/O components 220, 222, and 224, the memory components 230-1 to 230-N, and the processors 228-1 to 228-M. Those of ordinary skill in the art will understand that the functionalities of the switch 226 can be provided by one or more components of a computing device and do not have to be provided by an independent switching device or component as is illustrated in FIG. 2.

Various multiprocessor systems include a single computing device having multiple processors, a number of computing devices each having single processors, or multiple computing devices each having a number of processors. For example, computing systems can include a number of computing devices (e.g., computing device 100 of FIG. 1) that can communicate with each other.

The embodiments of the present invention, for example, can be useful in systems and devices where the processors operate under a single operating system. In this way, the operating system can monitor the threads executing under the operating system and can control the transfer thereof.

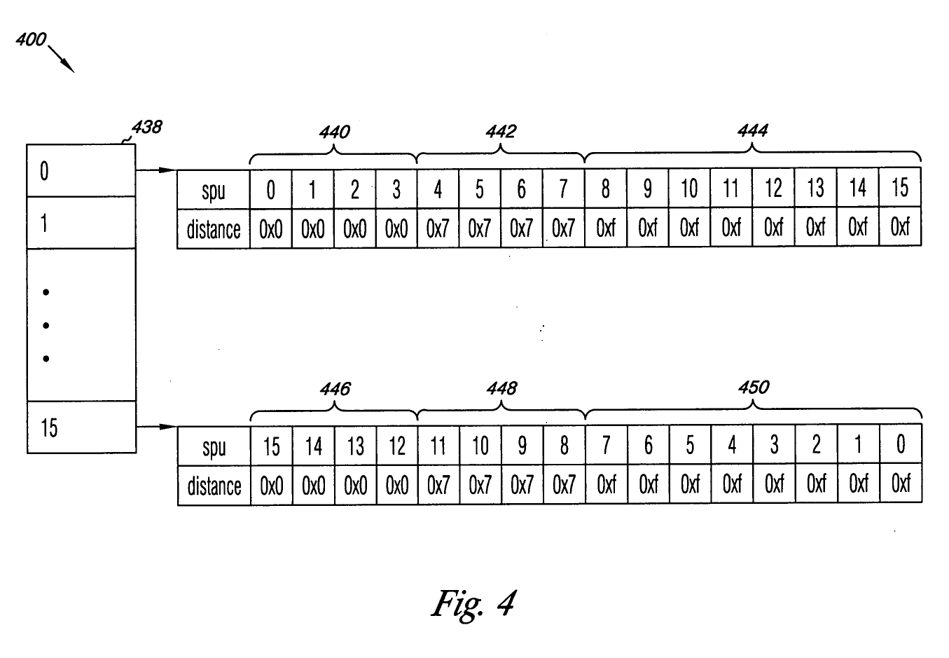

The distance between processors and resources can be determined in various manners. In various embodiments, computer executable instructions can be provided to determine the distance between localities, between processors, and/or processors and resources. For example, the hardware abstraction layer can include a catalog of processors, localities, and distances therebetween. Based upon this information, computer executable instructions can be used to define individual distances, and/or compile one or more table or other reference structures, such as table 400 shown in FIG. 4, among others.

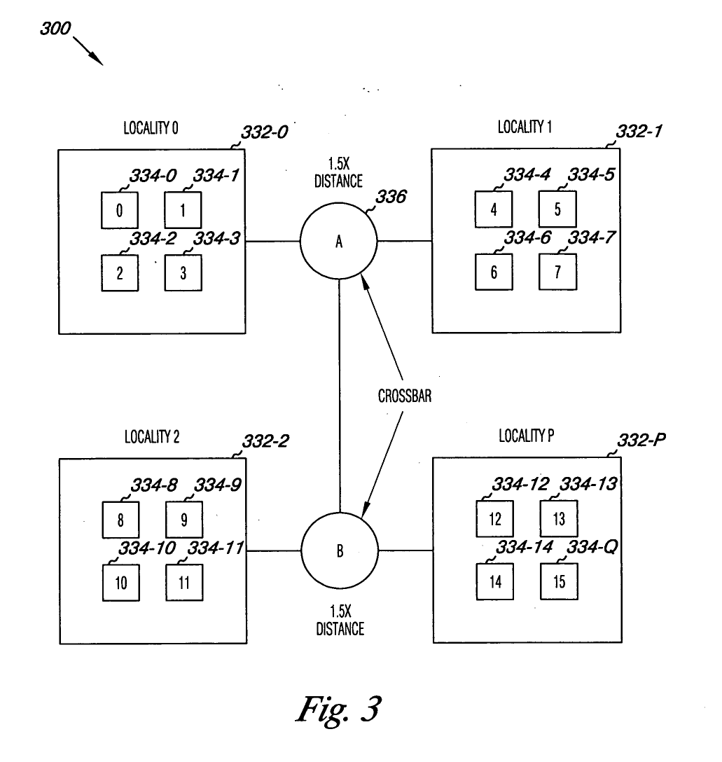

FIG. 3 illustrates an exemplary multiprocessor system including a number of localities. In the embodiment shown in FIG. 3, the system 300 includes four localities (i.e. 0, 1, 2, and P). The designators “P” and “Q” are used to indicate that a number of localities and/or processors can be part of the system 300. The number that P represents can be the same or different from the number represented by Q. The localities each contain a number of processors (e.g., four). In system 300, 16 processors 334-0 to 334-Q are provided (i.e., 0-15). Since this is a multiprocessor system or device, the processors can be used in parallel to process multiple threads at once.

Within a particular locality, the transfer of threads between processors (e.g., 334-0, 334-1, 334-2, and 334-3) is fastest and, therefore, no delay is assigned to such transfers. Embodiments of the present invention are designed to search these processors for threads to be transferred first, since there are no delays for such transfers. If no threads are available, then the next closest processor(s) can be searched.

The various localities are connected via a number of junctions 336 labeled crossbars A and B. When crossing a junction 336, such as from Locality 0 332-0 to Locality 1 332-1, a delay occurs based upon the distance between the two localities. For example, in FIG. 3, a delay having a weight of 1.5 has been assigned for transfers between localities 0 and 1.

Likewise, a delay having a weight of 1.5 has also been assigned for transfers between localities 2 and P. As will be understood by those of ordinary skill in the art from reading the present disclosure, these transfers are the next closest to those between processors within the same locality. Accordingly, in various embodiments, processors within a close locality can be searched after those within the locality of the idle processor. For example, if processor 334-1 is idle, the processors within its locality (e.g., 334-0, 334-2, and 334-3) are searched first, to identify if a thread can be transferred from either 334-0, 334-2, or 334-3.

If no thread is available for transfer, then processors 334-4, 334-5, 334-6, and 334-7 can be searched. Since these processors are all part of the same locality (i.e., 332-1) they can be searched in any order because, in the embodiment shown in FIG. 3, processors within the same locality are assigned the same distance with respect to processors in a different locality. In this way, processors can also be classified, or organized, into levels of proximity. However, the embodiments of the present invention are not so limited. In such embodiments, the wait time in a queue or the number of threads waiting to be execute are some of the criteria that can be used to determine the search order for the processors within a locality or other proximity classification or level

Additionally, since the distance is greater between localities 0 and 1 and 2 and P, the delays of 1.5 are combined and assigned for transfers between localities 0 and 1 and 2 and P. For example, a transfer between locality 0 and locality 1 has a weight of 1.5, while a transfer between locality 0 and 2 or P will have a weight of 3. Likewise, transfers between locality 1 and 2 or P also will have a weight of 3.

In various embodiments, transfers between these localities are searched after the search between processors within the same locality, and the search between close localities has been accomplished. For example, if processor 334-1 is idle, the processors within its locality (e.g., 334-0, 334-2, and 334-3) are searched first, to identify if a thread can be transferred from either 334-0, 334-2, or 334-3. If no thread is available for transfer, then processors 334-4, 334-5, 334-6, and 334-7 can be searched. If still there is no thread is available for transfer, then processors 334-8, 334-9, 334-10, 334-11, 334-12, 334-13, 334-14, and 334-Q can be searched.

In such embodiments, distance can be used to aid in the selection of threads to be transferred. However, those of ordinary skill in the art will understand from reading the present disclosure, a number of criteria can be used to determine how the selection of a processor and/or a thread can be determined.

FIG. 4 illustrates an example of the distances between a number of processors. A table 400 is shown in FIG. 4, in which a number of processors (SPU's 0-15) and their distances are shown. In the table shown, for each processor, the distance to the other processors of the device or system can be different. In the example shown, each processor shown at 438 includes a set of SPU's and distances. An example of the distance from processor 0 and an example of the distances from processor 15 are shown.

In FIG. 4, the layout of the processors 0-15 is similar to that shown in FIG. 3, except that the distances across one junction (e.g., crossbar) are shown in hexadecimal format (although not limited to this distance or unit of measure) as 0 X 7, while the distances for two junctions is shown as 0 X f. In the example regarding the distance from processor 0 shown in FIG. 4, no delay is assigned to the processors within processor 0's locality 440. The processors (e.g., 4, 5, 6, and 7) of the next closest locality are assigned a delay weight of 0 X 7 represented at 442. The processors (e.g., 8, 9, 10, 11, 12, 13, 14, and 15) of the two furthest localities are assigned the weight 0 X f represented at 444.

In the embodiment of FIG. 4, since the delay due to distance is determined from the perspective of the idle processor, the assigned values can be different for each processor. For example, since processor 15 is in a different locality from processor 0, the table for processor 15 provided in FIG. 4 is different than that for processor 0. In the example regarding the distance from FIG. 15, no weight is assigned to those processors within the locality of processor 15, represented at 446. The processors in the next closest locality (e.g., 8, 9, 10, and 11) are assigned a weight of 7, while the processors that will transfer via two junctions are given a distance of f represented at 450.

A table, such as that shown in FIG. 4, or other such distance reference structures can be provided within a system. In various embodiments, separate reference structures can be provided on one or more of the processors.

FIGS. 5 and 6 illustrate various method embodiments for transferring threads. As one of ordinary skill in the art will understand, the embodiments can be performed by software/firmware (e.g., computer executable instructions) operable on the devices shown herein or otherwise. The embodiments of the invention, however, are not limited to any particular operating environment or to software written in a particular programming language. Software, application modules, and/or computer executable instructions, suitable for carrying out embodiments of the present invention, can be resident in one or more devices or locations or in several locations.

Unless explicitly stated, the method embodiments described herein are not constrained to a particular order or sequence. Additionally, some of the described method embodiments or elements thereof can occur or be performed at the same point in time.

FIG. 5 illustrates one method embodiment for processing an thread. In block 510, the method of FIG. 5 includes selecting a processor wherein the selection is based upon proximity of the selected processor to the idle processor.

Proximity can be determined in various manners, for example, one such manner is shown above with respect to FIGS. 5 and 6. Other manners include user or manufacturer assignment based upon proximity, weighting structures to establish a weight for each distance, determination of a distance for each processor independently, and/or establishment of distance based upon a processor's locality. For example, determining a distance for each of a number of processors can include determining a distance for each of a number of localities, each including a number of processors, from a particular locality having the particular processor included therein and assigning the distance of each locality to the processors included therein.

In such embodiments, selecting a processor can include determining, from a number of processors that are in the same proximity from the idle processor, which processor has the most threads waiting for processing. This can be determined in various manners, such as by random selection, determining the queue with the longest wait time, determining a thread having commonalities with the previously executed threads of the idle processor, and the like.

The method also includes selecting a thread for transfer from the selected processor, at block 520. The method also includes transferring the thread from the selected processor to the idle processor, at block 530.

In various embodiments, the method also includes determining a local processor candidate in each of a number of localities each having a number of processor therein based upon comparing all of the processors in a particular locality. Method embodiments can include determining a global processor candidate based upon comparison of the local processor candidates from each of the number of localities.

Method embodiments can also include determining a processor candidate based upon comparing all of the processors in a number of localities each having a number of processor therein. In various embodiments, method embodiments can also include searching all processors within a first level of proximity before searching a processor in a second level of proximity.

Embodiments of the present invention can include methods that provide for assigning a weight to each processor based upon the number of threads waiting for processing thereon. In various embodiments, a distance can be determined for each of a number of localities, each including a number of processors, from a particular locality. Additionally, a distance can be determined for each of a number of processors from a particular processor.

FIG. 6 illustrates another method embodiment for handling threads. In block 610, the method of FIG. 6 includes determining a search hierarchy of the number of processors based upon proximity of each processor to the idle processor. The method also includes searching each of the number of processors, to select a processor having a number of threads waiting to be processed, wherein the selection of a processor to be checked is based upon the search hierarchy, in block 620.

At block 630, the method also includes selecting a thread for transfer from the selected processor. The method also includes transferring the thread from the selected processor to the idle processor, at block 640.

Threads can be bound in various manners. For example, threads can be bound to a particular processor. In such instances, the thread cannot be executed on another processor. Another type of binding is locality binding. In these instances, the thread cannot be moved outside the locality on which it resides. The above types of binding typically occur when the thread is associated with a process having a large amount of data or other resources within the locality of the processor. In various embodiments, the method of FIG. 6 can also include determining a number of threads that are bound. Method embodiments can also include determining whether to skip one or more of the number of bound threads. The method further includes determining threads bound to a processor and threads bound to one or more processors within a locality. Various method embodiments can also include determining threads bound to one or more processors within a locality.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of ordinary skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device, comprising:
a number of processors including a first processor;
a memory in communication with at least one of the number of processors; and
computer executable instructions stored in memory and executable on at least one of the number of processors to:
select a second processor, wherein the selection is based upon proximity of the second processor to the first processor;
select a thread for transfer from the second processor; and
transfer the selected thread from the second processor to the first processor.

2. The computing device of claim 1, wherein computer executable instructions are provided to determine the distance of each of the number of processors from the first processor.

3. The computing device of claim 1, wherein computer executable instructions are provided to determine whether each of the number of processors is located within a same locality as the first processor.

4. The computing device of claim 1, wherein computer executable instructions are provided to determine whether each of the number of processors is within a locality that is located across a junction from the first processor.

5. The computing device of claim 1, wherein computer executable instructions are provided to assign a weight to each processor based upon its proximity to the first processor.

6. The computing device of claim 5, wherein the computer executable instructions provided to select a processor include instructions to search each processor based upon the weight assigned thereto until a processor having a thread to be transferred is identified.

7. The computing device of claim 6, wherein the instructions to search include instructions to search a processor having a weight representing the processor that is most proximate to the first processor to a processor having a weight representing the processor that is least proximate.

8. A computing system, comprising:
a number of processors including an idle processor;
a memory; and
computer executable instructions in the memory which are executable to:
determine a search hierarchy of the number of processors based upon proximity of each processor to the idle processor;
search each of the number of processors, to select a processor having a number of threads waiting to be processed, wherein the selection of a processor to be checked is based upon the search hierarchy;
select a thread for transfer from the selected processor; and
transfer the thread from the selected processor to the idle processor.

9. The computing system of claim 8, wherein the number of processors are located in levels of proximity from the idle processor.

10. The computing system of claim 8, wherein computer executable instructions are provided to classify the number of processors according to each processor's location from the idle processor.

11. The computing system of claim 9, wherein the selection of a processor is accomplished by checking each of the number of processors for threads to be transferred based upon the processor's classification.

12. The computing system of claim 11, wherein computer executable instructions are provided to check each of the number of processors based upon the processor's classification by checking the processors from the processor located closest to the idle processor to the processor located the farthest from the idle processor.

13. The computing system of claim 8, wherein the computer executable instructions are provided by an operating system scheduler.

14. A method for selecting a thread for transfer, comprising:
selecting a processor wherein the selection is based upon proximity of the selected processor to an idle processor;
selecting a thread for transfer from the selected processor; and
transferring the thread from the selected processor to the idle processor.

15. The method of claim 14, wherein the method further includes determining a local processor candidate in each of a number of localities each having a number of processor therein based upon comparing all of the processors in a particular locality.

16. The method of claim 14, wherein the method further includes determining a global processor candidate based upon comparison of the local processor candidates from each of the number of localities.

17. The method of claim 14, wherein the method further includes determining a processor candidate based upon comparing all of the processors in a number of localities each having a number of processor therein.

18. The method of claim 14, wherein the method further includes searching all processors within a first level of proximity before searching a processor in a second level of proximity.

19. A computer readable medium having instructions for causing a device to perform a method, comprising:
selecting a processor wherein the selection is based upon proximity of the selected processor to an idle processor;
selecting a thread for transfer from the selected processor; and
transferring the thread from the selected processor to the idle processor.

20. The computer readable medium of claim 19, wherein selecting a processor further includes determining, from a number of processors that are the same proximity from the idle processor, which processor has the most threads waiting for processing.

21. The computer readable medium of claim 19, wherein further including assigning a weight to each processor based upon the number of threads waiting for processing thereon.

22. The computer readable medium of claim 19, wherein the method further includes determining a distance for each of a number of localities, each including a number of processors, from a particular locality.

23. The computer readable medium of claim 19, wherein the method further includes determining a distance for each of a number of processors from a particular processor.

24. The computer readable medium of claim 19, wherein determining a distance for each of a number of processors includes determining a distance for each of a number of localities, each including a number of processors, from a particular locality having the particular processor included therein and assigning the distance of each locality to the processors included therein.

25. A method for selecting a thread for transfer, comprising:
determining a search hierarchy of the number of processors based upon proximity of each processor to an idle processor;
searching each of the number of processors, to select a processor having a number of threads waiting to be processed, wherein the selection of a processor to be checked is based upon the search hierarchy;
selecting a thread for transfer from the selected processor; and
transferring the thread from the selected processor to the idle processor.

26. The method of claim 25, wherein the method further includes determining a number of threads that are bound.

27. The method of claim 26, wherein the method further includes determining whether to skip one or more of the number of bound threads.

28. The method of claim 26, wherein the method further includes determining threads bound to a processor and threads bound to one or more processors within a locality.

29. The method of claim 26, wherein the method further includes determining threads bound to one or more processors within a locality.
